(19) United States
(12) Patent Application Publication
(10) Pub. No.: US 2014/0369231 A1
(43) Pub. Date: Dec. 18, 2014

(54) SMART HOME NETWORK SYSTEM AND METHOD FOR REGISTERING HOME DEVICES

(71) Applicants: HON HAI PRECISION INDUSTRY CO., LTD., NEW TAIPEI (TW); HONG FU JIN PRECISION INDUSTRY (SHENZHEN) CO., LTD ., SHENZHEN (CN)

(72) Inventors: TE-SHENG CHEN, New Taipei (TW); XIAO-GUANG LI, Shenzhen (CN); KUAN-HONG HSIEH, New Taipei (TW); YUN XIAO, Shenzhen (CN); SHANG-HUI PI, Shenzhen (CN)

(73) Assignees: HON HAI PRECISION INDUSTRY CO., LTD., NEW TAIPEI (TW); HONG FU JIN PRECISION INDUSTRY (SHENZHEN) CO., LTD ., SHENZHEN (CN)

(21) Appl. No.: 14/014,387

(22) Filed: Aug. 30, 2013

(30) Foreign Application Priority Data
Jun. 14, 2013 (CN) 2013102363522

(51) Int. Cl. H04L 12/24

(52) U.S. Cl. CPC H04L 41/0889; H04L 41/0883
USPC 370/254

(57) ABSTRACT

A smart home network system with a method for registering new home devices includes a number of home devices, a smart gateway, and a register controller. The smart gateway assigns a register region and a region name in a mapping list stored in the smart gateway. The register controller generates and sends a registration command to the home devices in the area where the register controller is placed, in order to control the home devices to register their respective configuration information in corresponding register region in the mapping list. Therefore, the smart gateway is able to control each home device.

### BACKGROUND

1. Technical Field

The present disclosure relates to smart home technology, and particularly to a smart home network system, and a method for registering home devices.

2. Description of Related Art

Smart home technology is becoming popular. With this technology, devices in a house are connected to a smart home network system, to be controlled by the smart home network system.

When a new home device needs to be connected to the smart home network system, the device needs to be registered with the smart home network system. However, the existing registration process is complicated and inconvenient for the user.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a smart home network system, according to an embodiment.

FIG. 2 is a block diagram of a smart gateway of the smart home network system of FIG. 1.

FIG. 3 is a schematic diagram of a mapping list stored in the smart gateway of FIG. 1.

FIG. 4 is a block diagram of a register controller of the system of FIG. 1.

FIG. 5 is a block diagram of a home device of the system of FIG. 1.

FIG. 6 is a schematic diagram of a control interface displayed on the smart gateway of FIG. 2 or on a control device.

### DETAILED DESCRIPTION

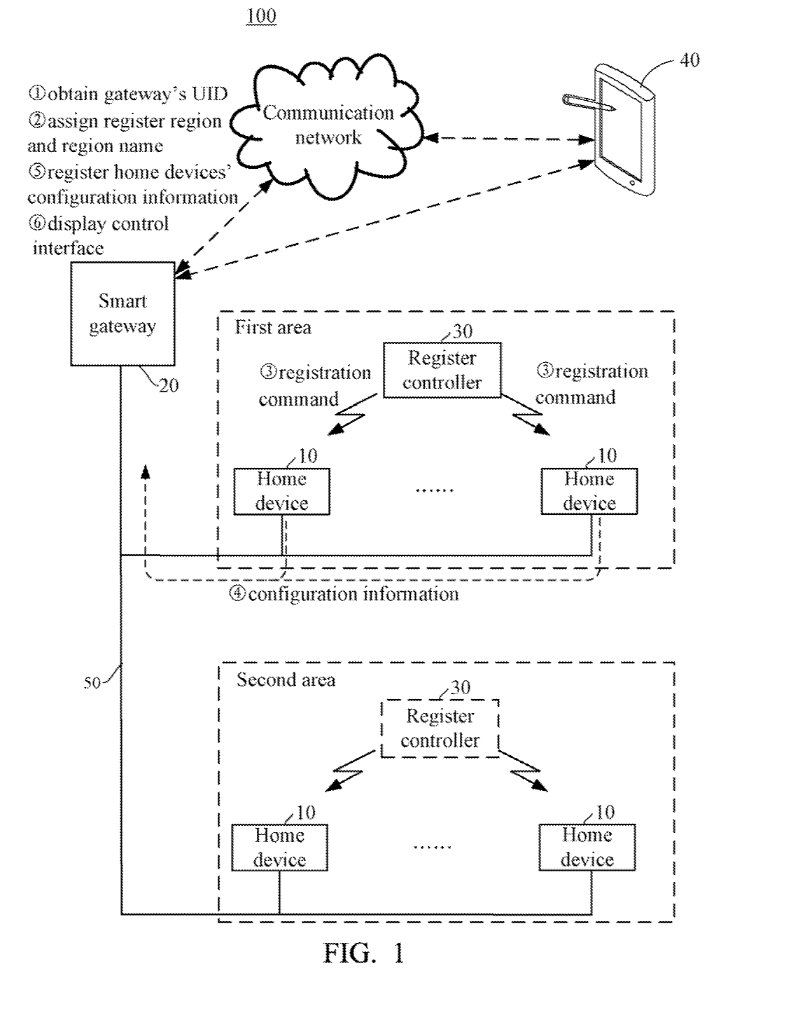

FIG. 1 shows a smart home network system 100 of the embodiment. The system 100 includes a number of home devices 10 and a smart gateway 20. The smart gateway 20 is connected to a communication network. The home devices 10 may include, but not be limited to, a refrigerator, an air conditioner, an electric curtain, a lamp, and a smart socket.

In this embodiment, each device in the system 100 is provided with a unique identification (UID) code so that it can be identified by other devices.

Each home device 10 needs to register its configuration information with the smart gateway 20, when the home device 10 is connected to the system 100 for the first time or reconnected, to allow the smart gateway 20 to control each home device 10.

In this embodiment, the system 100 further includes a register controller 30, which can be moved to different areas (such as a living room or a kitchen) of the house at different times. Each register controller 30 controls all of the home devices 10 in the area where the register controller 30 is placed to register their configuration information with the smart gateway 20.

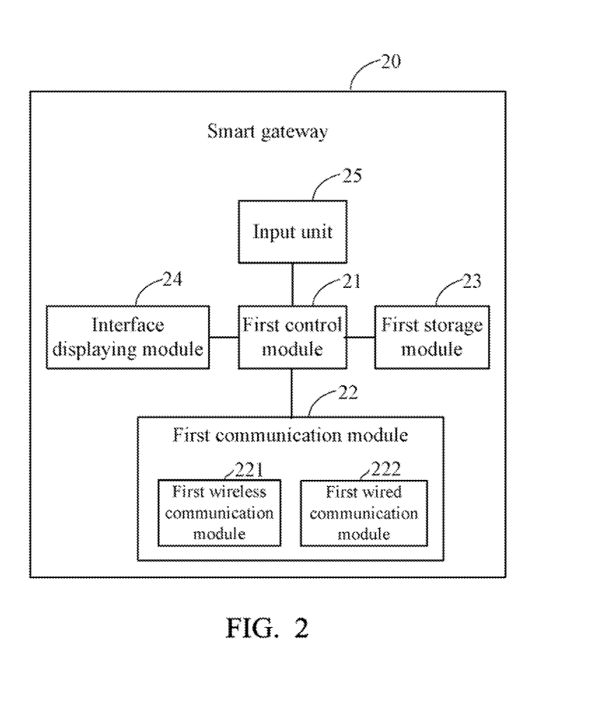

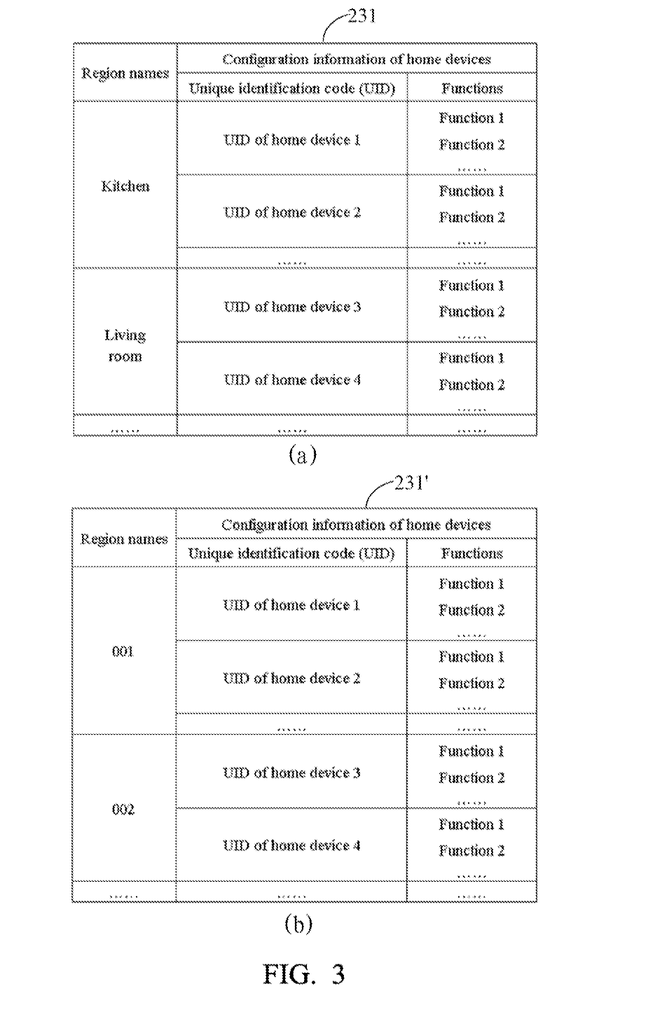

Referring to FIG. 2, in this embodiment, the smart gateway 20 includes a first control module 21, a first communication module 22, a first storage module 23, and an interface displaying module 24. The first storage module 23 stores the UID code of the smart gateway 20 and a mapping list 231 (as shown in FIG. 3). The mapping list 231 records the configuration information of each home device 10 in the system 100.

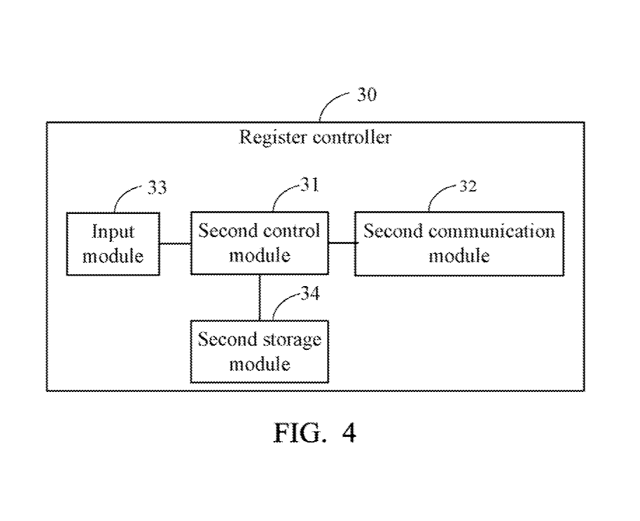

Referring to FIG. 4, the register controller 30 includes a second control module 31, a second communication module 32, an input module 33, and a second storage module 34. The input module 33 is a button or a touch screen on the register controller 30 configured to allow user input.

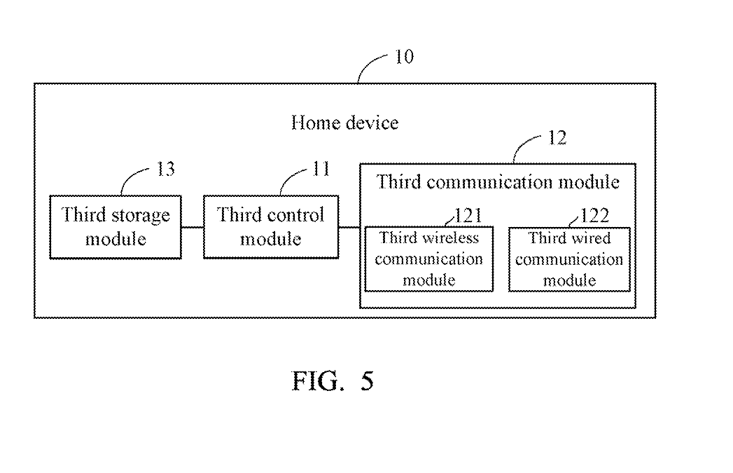

Referring to FIG. 5, each home device 10 includes a third control module 11, a third communication module 12, and a third storage module 13. The third storage module 13 stores the configuration information containing the UID code and functions of the home device 10.

Functions of the above modules of the home device 10, the smart gateway 20, and the register controller 30 will be described.

In this embodiment, the register controller 30 communicates with the home devices 10 and the smart gateway 20 via wireless communication technology. Referring again to FIGS. 2, 4 and 5, in this embodiment, the first communication module 22 includes a first wireless communication module 221, and the third communication module 12 includes a third wireless communication module 121. The first wireless communication module 221, the second communication module 32, and the third wireless communication module 121 can all emit and receive near field wireless signals. The near field wireless signals may include, but not be limited to, infrared, BLUETOOTH, Z-WAVE, NFC, ZIGBEE, and WIFI signals. In this embodiment, each of the first wireless communication module 221, the third wireless communication module 121, and the second communication module 32 is an infrared signal transceiver.

The smart gateway 20 also communicates with the home devices 10 via wired communication technology. In this embodiment, the first communication module 22 further includes a first wired communication module 222, and the third communication module 12 further includes a third wired communication module 122. The first wired communication module 222 and the third wired communication module 122 communicate with each other via Power Line Communication (PLC), Optical Fiber Power Line Communication (OPLC), or via the Internet, coaxial cable, telephone line, or other communication technologies.

In this embodiment, the smart gateway 20 is connected to each home device 10 via power lines 50, and the first wired communication module 222 and the third wired communication module 122 communicate with each other via PLC or OPLC technologies. Each of the first wired communication module 222 and the third wired communication module 122 is a modem module, which gathers data from or transmits data into the power lines 50. Therefore, the power lines 50 not only supply power to the devices, but also serve as data carriers.

Specifically, the first wired communication module 222 and the third wired communication module 122 receive incoming data packets (PLC or OPLC data packets) from the power lines 50, and demodulate the data packets and convert network protocols as required. The first wired communication module 222 and the third wired communication module 122 also modulate data for transmission and convert network protocols, and then send the modulated data to other devices via the power lines 50. With such a structure, the home devices 10 can be connected to the system 100 by being directly plugged into existing power sockets in existing wiring of a house.

Referring again to FIG. 1, a method for registering a number of home devices 10 with the smart gateway 20 is also illustrated.

In step 1, the register controller 30 obtains the UID code of the smart gateway 20 via the second communication module 32, and stores the UID code of the smart gateway 20 in its second storage module 34.

In this embodiment, the first control module 21 of the gateway 20 controls the first wireless communication module 221 to send the UID code of the gateway 20 to the second communication module 32 of the register controller 30. Because the wireless technology employed is infrared transmission, the register controller 30 is located close to the smart gateway 20, such that the register controller 30 is within range of the infrared signal.

In step 2, the gateway 20 initiates a registration process, and the first control module 21 of the smart gateway 20 assigns a register region and a region name in the mapping list 231 for all home devices placed a particular area, such as a first area.

In one embodiment, the smart gateway 20 further includes an input unit 25 (as shown in FIG. 2) whereby user can input a region name, such as “kitchen”, in the input unit 25, and the first control module 21 assigns a register region named “kitchen” in the mapping list 231 (as shown in FIG. 3(a)). In another embodiment, the first control module 21 defines a region name according to a numerical order, such as “001”, and assigns a register region named “001” in the mapping list 231 (as shown in FIG. 3(b)).

In step 3, when the register controller 30 is brought to the particular area, the second control module 31 of the register controller 30 generates a registration command in response to an operation on the input module 33. Then the second control module 31 controls the second communication module 32 to send the registration command to all of the home devices 10 in the first area.

In this embodiment, the second control module 31 controls the second communication module 32 to wirelessly send the registration command to all the home devices 10 placed in the first area. The registration command contains the UID code of the smart gateway 20.

In step 4, when the home devices 10 in the first area receive the registration command from the register controller 30, the third control modules 11 control the third communication modules 12 to send their respective configuration information to the smart gateway 20.

In this embodiment, the home devices 10 receive the registration command from the register controller 30 via their third wireless communication modules 121, and send their configuration information to the smart gateway 20 via their third wired communication modules 122 and the power lines 50, according to the UID code of the smart gateway 20 contained in the registration command.

In step 5, when the first communication module 22 of the smart gateway 20 receives the configuration information from the home devices 10, the first control module 21 registers the configuration information of the home devices 10 in the corresponding register region in the mapping list 231. Therefore, the configuration information of all the home devices 10 in one area is registered in the same register region in the mapping list 231.

If a new home device 10 is added to a registered area (that is, the configuration information of the home devices in the area having already been registered in the mapping list 231 of the smart gateway 20) and needs to be registered with the smart gateway 20, the process repeats steps 2˜5 again.

Since the UID code of each home device 10 is unique, the configuration information of each home device 10 will only be registered once in the mapping list 231. If a home device 10 is moved to a new area, the configuration information of the home device 10 registered in an original register region in the mapping list 231 will be deleted, and the configuration information of the moved home device 10 will be registered in a new register region in the mapping list 231.

The registration process for other home devices 10 placed in other areas is similar to that of steps 2˜5.

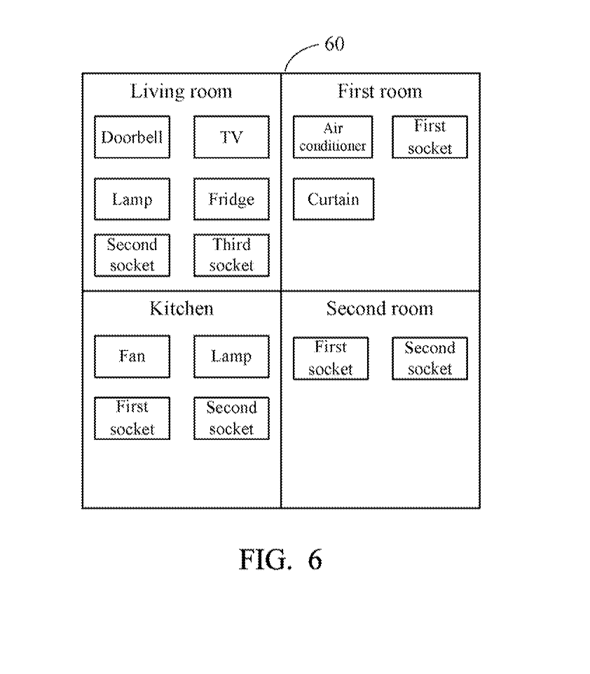

In step 6, the interface displaying module 24 of the smart gateway 20 displays a control interface 60 (as shown in FIG. 6), according to the mapping list 231. In this embodiment, the control interface 60 includes a number of regions corresponding to the areas in the house. Each region includes a number of icons corresponding to the home devices 10 placed in that area in the house, and each icon includes control options to control the home device 10.

In this embodiment, the interface displaying module 24 displays a schematic diagram of the regions according to the region names of the mapping list 231, displays the icons of the home devices 10 in the regions according to their UID codes and the region names registered in the mapping list 231, and displays the control options for those icons according to the functions of the corresponding home devices 10 registered in the mapping list 231.

Such that, the registration process of the home devices 10 with the smart gateway 20 in the embodiment is completed.

Referring again to FIG. 1, the system 100 further includes a control device 40. The control device 40 may be selected from a group consisting of a smart phone, tablet computer, and other remote control device. The control device 40 communicates with the smart gateway 20 via wired or wireless communication technologies. The control device 40 displays the control interface 60 according to the mapping list 231 stored in the smart gateway 20, such that the user can control each of the home devices 10 remotely.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A smart home network system comprising a plurality of home devices, a smart gateway and a register controller,
the smart gateway comprising:
a first storage module storing a mapping list;
a first communication module configured to receive configuration information from the home devices; and
a first control module configured to assign a register region and a region name in the mapping list for the home devices, and register the configuration information of the home devices in the corresponding register region in the mapping list;
the register controller comprising:
a second storage module storing a UID code of the smart gateway;
a second control module and an input module, the second control module configured to generate a registration command in response to an operation on the input module, wherein the registration command contains the UID code of the smart gateway; and
a second communication module configured to send the registration command to the home devices in the particular area where the register controller is placed; and
each home device comprising a third communication module which is configured for sending the configuration information of the home device to the smart gateway when it receives the registration command from the register controller.

2. The system as described in claim 1, wherein the first communication module of the smart gateway comprises a first wireless communication module, and wherein the first wireless communication module is configured to wirelessly send the UID code of the gateway to the second communication module of the register controller.

3. The system as described in claim 2, wherein the third communication module of the home device comprises a third wireless communication module, and the second communication module of the register controller wirelessly sends the registration command to third wireless communication module.

4. The system as described in claim 3, wherein the first wireless communication module, the second communication module, and the third wireless communication module all emit and receive near field wireless signals, and wherein the near field wireless signal is selected from a group consisting of infrared, BLUETOOTH, Z-WAVE, NFC, ZIGBEE, and WIFI signals.

5. The system as described in claim 1, wherein the first communication module comprises a first wired communication module, and the third communication module comprises a third wired communication module; the smart gateway is connected to each home device via power lines, and the home device sends its configuration information to the first wired communication module of the smart gateway via the third wired communication module and the power lines.

6. The system as described in claim 5, wherein the first wired communication module and the third wired communication module communicate with each other via PLC or OPLC technologies.

7. The system as described in claim 1, wherein the smart gateway further comprises an interface displaying module, the interface displaying module is configured to display a control interface according to the mapping list.

8. The system as described in claim 1, further comprising a control device, wherein the control device communicates with the smart gateway, and displays a control interface according to the mapping list stored in the smart gateway.

9. A method applied to a smart home network system, for registering a plurality of home devices with a smart gateway, the system further comprising a register controller, the method comprising:
obtaining an UID code of the smart gateway using the register controller;
assigning a register region and a region name in a mapping list stored in the smart gateway using the smart gateway;
generating a registration command using the register controller when the register controller is carried to a particular area;
sending the registration command to all of the home devices in the particular area using the register controller;
sending their respective configuration information to the smart gateway using the home devices when the home devices receive the registration command from the register controller;
receiving the configuration information from the home devices, and registering the configuration information in the corresponding register region in the mapping list using the smart gateway.

10. The method as described in claim 9, further comprising:
displaying a control interface using the smart gateway according to the mapping list.

11. The system as described in claim 9, wherein the register controller wirelessly sends the registration command to the home devices.

12. The system as described in claim 11, wherein the register controller and the home devices emit and receive near field wireless signals, and the near field wireless signal is selected from a group consisting of infrared, BLUETOOTH, Z-WAVE, NFC, ZIGBEE, and WIFI signals.

13. The method as described in claim 9, wherein the smart gateway is connected to each home device via power lines, and the home devices send their configuration information to the smart gateway via the power lines.

14. The method as described in claim 13, wherein the smart gateway communicates with the home devices via PLC or OPLC technologies.
